(19) United States
(12) Patent Application Publication
(10) Pub. No.: US 2006/0020732 A1
(43) Pub. Date: Jan. 26, 2006

(54) Modular USB port replicator

(76) Inventor: Sharon Lin Charna, Newport Coast, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(21) Appl. No.: 11/114,701

(22) Filed: Apr. 26, 2005

Related U.S. Application Data
(60) Provisional application No. 60/591,380, filed on Jul. 26, 2004.
(60) Provisional application No. 60/610,235, filed on Sep. 16, 2004.

(51) Int. Cl. G06F 13/00

(52) U.S. Cl. 710/303

(57) ABSTRACT

A modular USB port replicator is provided to facilitate intercommunication between an electronic device equipped with any kind of interface and a computer through a USB cable line. The replicator includes at least an interface conversion module and a USB processing module. The interface conversion module has an interface corresponding to that of the electronic device to be connected, and after connection is made, input/output signals of the electronic device are converted by the interface conversion module. One end of a USB processing module is connected with an interface conversion module through a USB signals line, while the other end with a computer through a USB cable line. By such configuration, after acknowledging the presence of the electronic device, the interface conversion module is to inform the computer the same so that the computer can fully control the electronic device.

### BACKGROUND OF THE INVENTION

1. Field of the Invention

The present invention is about a modular Universal Serial Bus (USB) port replicator that simplifies the way a computer or computers interface with a set of computer and electronic peripherals.

2. The Prior Arts

Most computer peripherals, such as webcam and memory card-reader, usually interface with a personal computer (PC) through the same type of interface.

The USB (Universal Serial Bus) interface is the most common interface used in personal computers. USB offers benefits such as product hot swap with good adaptability, and it is now available in USB 2.0, which supports 480 Mbps data transfer. Almost all motherboards today offer more than six on-board USB 2.0 interfaces. Older motherboards and those lacking multiple USB interfaces will require a USB Hub for expansion. However, older non-USB peripherals often have problems in interfacing with new USB computers.

Furthermore, users today often own more than two computers, as a consequence of which, the users need a considerable space to accommodate all of the peripherals on the desktop. To resolve this problem, peripheral sharing is made through LAN (Local Area Network). Nevertheless, this practice is available to few peripherals, such as printers. Alternatively, KVM switches find their way into the market by offering a way to share a set of keyboard, monitor, and mouse among multiple computers. However, most KVM switches do not allow sharing of network connection, and most of them have limited support for sharing USB and audio peripherals.

### SUMMARY OF THE INVENTION

The first objective of the invention is to present a modular USB port replicator that enables electronic peripherals with different interfaces to communicate with a computer through a single USB cable.

The second objective of the invention is to present a modular USB port replicator that offers peripheral sharing functions that allow multiple computers to share a group of peripherals.

The third objective of the invention is to present a modular USB port replicator that offers additional connectivity function via simple connection of additional modules.

The modular USB port replicator comprises an interface conversion module and a USB processor. The interface conversion module provides an interface for connecting an electronic device such that the input or output signals of the electronic device can be converted. One end of the USB processor is coupled with the interface conversion module through USB signal, and the other end is connected with a computer through a USB cable. The electronic device can then communicate with the computer through the interface conversion module. As a result, the computer can control the electronic device via the modular USB port replicator.

For more detailed information regarding advantages and features of the present invention, one example of preferred embodiment will be described below with reference to the annexed drawings.

### BRIEF DESCRIPTION OF THE DRAWINGS

The related drawings in connection with the detailed description of the present invention to be made later are described briefly as follows, in which:

FIGS. 1A and 1B are schematic configurations of a modular USB port replicator of the present invention;

FIG. 2 is a schematic view of switch control of the present invention; and

FIG. 3 is a schematic view of cascade connection of the present invention.

### DETAILED DESCRIPTION OF THE PREFERRED EMBODIMENT

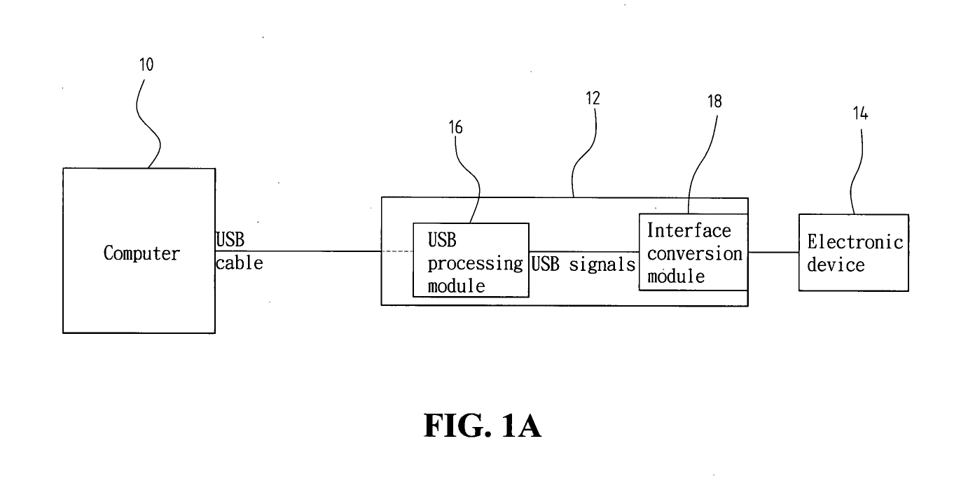

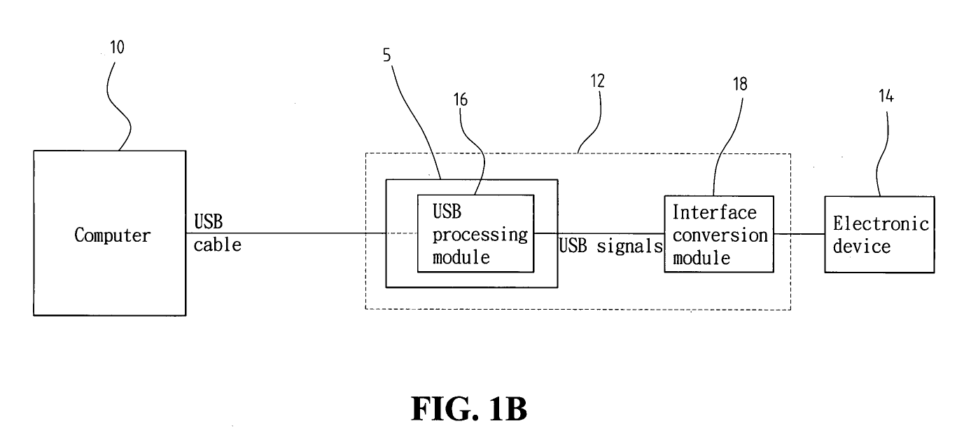

FIGS. 1A and 1B are schematic configurations of a modular USB (Universal Serial Bus) port replicator of the present invention. As shown in FIG. 1A, a modular USB port replicator (12) comprises a USB processing module (16) and an interface conversion module (18), in which the interface conversion module (18) could be a built-in or an add-on interface conversion module as indicated in FIG. 1A or FIG. 1B.

If the interface conversion module (18) is a built-in module, the exposed interface of the modular USB port replicator (12) is just the interface of the interface conversion module (18) corresponding to an electronic device (14). For example, if the electronic device (14) is a PS/2 mouse, then the exposed interface of the modular USB port replicator (12) is a PS/2 interface.

If the interface conversion module (18) is an add-on module as illustrated in FIG. 1B, the interface conversion module (18) comprises an USB interface, which allows the modular USB port replicator (12) to connect to the add-on interface conversion module (18) through a USB interface of the USB processing module (16).

The interface conversation module (18) can take the form of a built-in or add-on module. Consequently, it is possible to allow a built-in and an add-on interface conversion module. In other words, the USB interface device (5) may be a) an add-on module with a USB interface, or b) a built-in interface conversion module with an exposed device interface, such as PS/2.

The design described above allows an electronic device (14) to communicate with a computer (10), such as desktop computer, notebook computer, palm computer, and personal digital assistant (PDA), through a USB cable. The interactions between the USB processing module (16) and the interface conversion module (18), is described as follows.

After connection is made between the interface conversion module (18) and the electronic device (14), the output and input signals of the electronic device (14) are transferred through the interface conversion module (18). One end of the USB processing module (16) is connected to the interface conversion module (18), and the other end is connected to the computer (10) through the USB cable. After the interface conversion module (18) acknowledges the connection of electronic device (14), it then informs the computer (10). The computer (10) controls the electronic device (14) via the modular USB port replicator (12). Consequently, the electronic device (14), which is not a USB device, can then be recognized as a USB device to the computer (10). In summary, there are several types of electronic device (14) with different interfaces that can communicate with the computer (10) through a single USB cable.

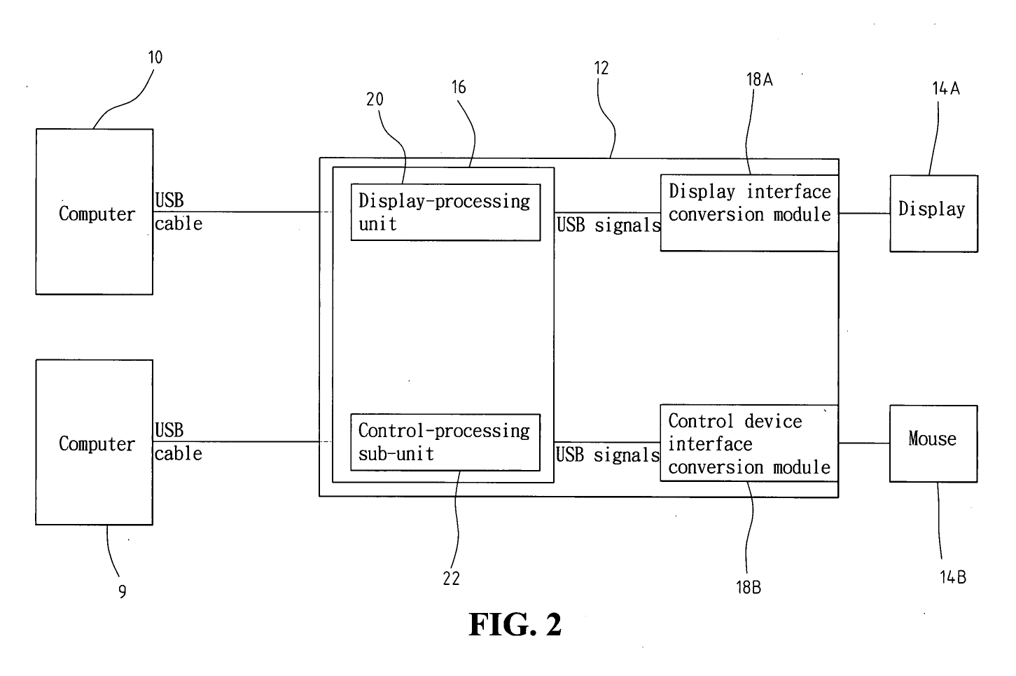

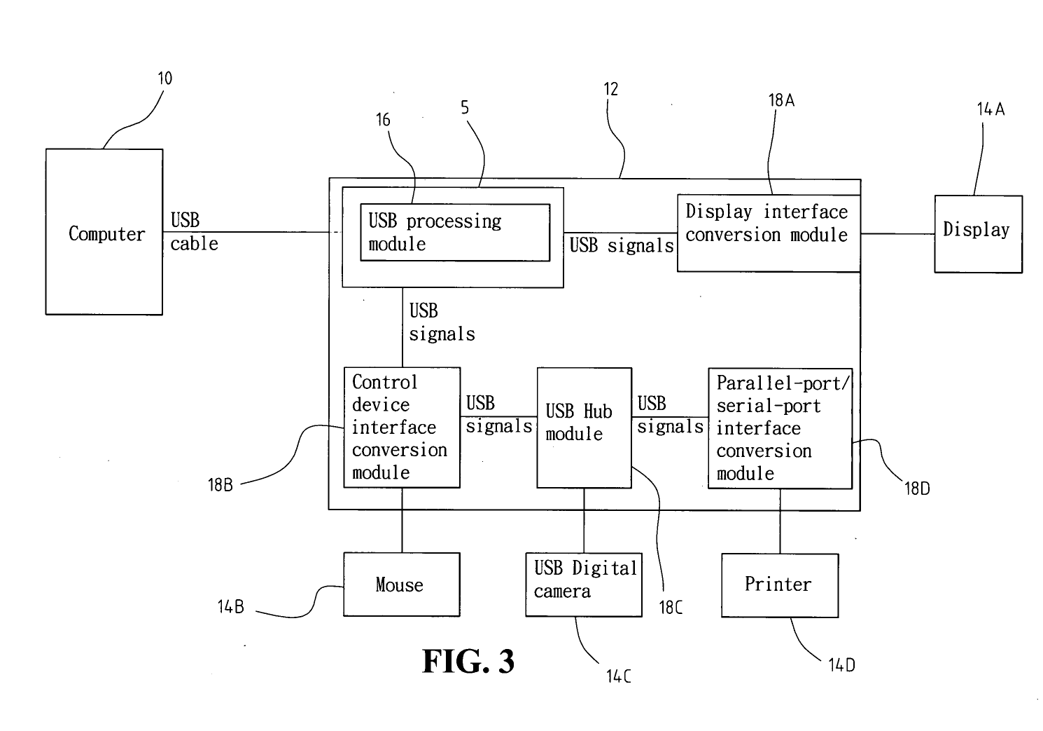

FIG. 2 is a schematic view of switching control of the present invention. Different interface conversion modules are allowed to connect to the modular USB port replicator (12). As shown in FIG. 2, the interface conversion module (18) of the modular USB port replicator (12) could be a display interface conversion module (1 8A), a CD-drive interface conversion module (not shown), a card-reader interface conversion module (not shown), a control device interface conversion module (1 8B), a network interface conversion module (not shown), a USB hub module (18C) (see FIG. 3), a parallel-port/serial-port interface conversion module (1 8D) (see FIG. 3), or a multimedia device module (not shown). The display interface conversion module (18A) is designed to work with an electronic device (14A), such as a video graphics array (VGA) LCD, plasma display panel (PDP), and a cathode ray tube (CRT) display. The control device interface conversion module (1 8B) is designed to work with an electronic device (14B), such as a mouse and a keyboard. The USB hub module (18C) allows connection of multiple USB devices to the computer (10). In the case of a network interface conversion module, the electronic device could be a network hub or a network/web device, while the cable used for connecting with the electronic device (14) is the network cable. In conclusion, different cords, cables, or signal lines for coupling modules of different types with the electronic device (14) can be adopted depending on the characteristics of each module.

As illustrated in FIG. 2, in the modular USB port replicator (12), the interface conversion module (18) comprises a display interface conversion module (18A) and a control device interface conversion module (18B). The USB processing module (16) is connected with two computers (9) and (10) and comprises a display-processing unit (20) and a control-processing sub-unit (22).

When the display-processing unit (20) receives a switching command designating the computer (10) as a controlled computer, a display signal of the computer (10) is shown on the display (14A). When the control-processing unit (22) receives a switching command, control signals for the computer (10) are provided by the mouse (14B). The switching command may be generated by (I) pressing a push button, (II) hotkey control (Ctrl+Shift+A for example), or (III) mouse click (at an operation screen for example).

As a result, a response made by the computer (10) to the control signals is shown on the display (14A). Therefore, it is possible to control different computers through a switching operation using a single display (14A) and a single control device (14B), which is a mouse in this case.

Since the present invention is capable of accommodating multiple interface conversion modules (18) in different forms, it is possible for several computers to share all the computer peripherals by connecting the electronic devices (14) in the forms of various computer peripherals with corresponding interface conversion modules (18).

FIG. 3 is a schematic view of cascade connection of the present invention. As indicated in FIG. 3, in the modular USB port replicator (12), both the display interface conversion module (18A) and the control interface conversion module (18B) are coupled with the USB device (5) that comprises a USB processing module (16) in the manner shown in FIG. 1B. The computer (10) may connect with a display (14A) and a mouse (14B) by the display interface conversion module (18A) and the control interface conversion module (18B).

To add additional functions to the modular USB port replicator (12), the user can add more add-on modules. For example, as shown in FIG. 3, the control interface conversion module (18B) is connected with a USB hub module (18C) by means of such USB interface. Furthermore, the USB Hub module (18C) could be extended to connect with an interface conversion module, such as a parallel-port/serial-port interface conversion module (18D), through another USB interface. As illustrated, a USB digital camera (14C), which is connected to the USB Hub module (18C), and a printer (14D), which is connected with the parallel-port/serial-port interface conversion module (1 8D), can both communicate with the computer (10).

The modular USB port replicator (12) of the present invention does not restrict the order of module connection. In other words, based on user's preference, users can connect different types of add-on modules, such as a USB hub module, a memory card module, and an external drive module, to the port replicator in any order desired.

The descriptions above have provided applications with reference to the drawings annexed. It has presented that numerous variations or modifications may be made without departing from the design concept thereof, as set forth in the claims below.

What is claimed:

1. A modular USB port replicator, through which an electronic device having an interface of any kind communicates with a computer via a USB cable, the replicator comprising:
an interface conversion module, having a coupling interface mateable with a counterpart interface of the electronic device, through which, after connection between the interface conversion module and the electronic device is made, input/output signals of the electronic device are converted by the interface conversion module; and
a USB processing module, having one end connected to the interface conversion module and other end connected to the computer via the USB cable, through which, after acknowledging the presence of the electronic device, the interface conversion module informs the computer to control the electronic device via the modular USB port replicator.

2. The modular USB port replicator as claimed in claim 1, wherein the computer is one of desktop computer, notebook computer, palm computer, and personal digital assistant.

3. The modular USB port replicator as claimed in claim 1, wherein the interface conversion module selectively comprises a display interface conversion module, a CD-drive interface conversion module, a card-reader interface conversion module, a control device interface conversion module, a network interface conversion module, a USB hub module, a parallel-port/serial-port interface conversion module, and a multimedia device module.

4. The modular USB port replicator as claimed in claim 3, wherein the control device interface conversion module is adapted to selectively connect to a VGA screen, a mouse, and a keyboard.

5. The modular USB port replicator as claimed in claim 3, wherein the display interface conversion module is connected with an electronic device selectively of VGA of liquid crystal display, VGA of plasma display panel, and VGA of cathode ray tube.

6. The modular USB port replicator as claimed in claim 3, wherein the USB processing module is coupled with two computers and wherein when the modular USB port replicator comprises the display interface conversion module and the control device interface conversion module, the USB processing module further comprises:
a display-processing unit, for making a display signal of a computer shown on an electronic device, which is connected with the display interface conversion module, and which, upon receipt of a switching command, designates the computer as a computer to be controlled; and
a control-processing unit, for enabling an electronic device, which is connected with the control device interface conversion module, to provide a control signal upon receipt of the switching command.

7. The modular USB port replicator as claimed in claim 3, wherein a plurality of interface conversion modules communicate with each other through the USB interface.
